(19) United States
(12) Patent Application Publication
(10) Pub. No.: US 2010/0226147 A1
(43) Pub. Date: Sep. 9, 2010

(54) LIGHTWEIGHT LIGHT GUIDE PLATE AND BACKLIGHT MODULE THEREOF

(75) Inventors: Cheng-Sheng Chiang, Taipei County (TW); Po-Fu Kuo, Taipei City (TW); Tsao-Yuan Fu, Taoyuan County (TW); Hui-Ju Hsu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/542,692

(22) Filed: Aug. 17, 2009

(30) Foreign Application Priority Data
Mar. 6, 2009 (TW) 98203482

(51) Int. Cl. F21V 8/00

(52) U.S. Cl. 362/628

(57) ABSTRACT

A lightweight light guide plate and a backlight module thereof are provided. The backlight module includes a light guide plate whose thickness gradually reduces from four edges to a center point of a light guide plate body to form a concave, an optical film group disposed on a plane of the light guide plate body, net points disposed on the concave, in which a unit area density of the net points gradually increases from the four edges to the center point of the light guide plate body respectively, LEDs respectively disposed at the four edges of the light guide plate body, a reflector corresponding to the concave of the light guide plate body, and a back frame having the reflector disposed thereon. The weight of the light guide plate body and backlight module thereof can be reduced, and the cost of materials for the light guide plate can be reduced.

### CROSS-REFERENCE TO RELATED APPLICATION

This application claims the priority benefit of Taiwan application serial no. 98203482, filed Mar. 6, 2009. The entirety of the above-mentioned patent application is hereby incorporated by reference herein and made a part of specification.

### BACKGROUND OF THE INVENTION

1. Field of the Invention

The present invention generally relates to a light guide plate and a backlight module thereof, in particular, to a lightweight light guide plate and a backlight module thereof, which are applied in a field of reducing a weight of a light guide plate and a backlight module thereof.

2. Description of Related Art

As the manufacturing technology of a liquid crystal display (LCD) device has made rapid progress, and the LCD device has advantages of being light, thin, power-saving, and free of radiation, the LCD device has been widely applied in industries such as personal digital assistants (PDAs), notebook computers, liquid crystal screens, and televisions. However, as the LCD device is not a self light-illuminance display device, it displays images under the assistance of a light source provided by a backlight module. In order to enable the LCD device to meet a thin-type requirement, the thin-type design of the backlight module in the LCD device becomes the foremost challenge. Currently, a conventional backlight module using a side-type light source is able to meet the thin-type requirement. As shown in FIG. 1, the conventional backlight module 1 includes a light guide plate 11, an optical film group 12 disposed on an upper surface of the light guide plate 11, a plurality of net points 13 disposed on a lower surface of the light guide plate 11, in which a unit area density of the plurality of net points 13 gradually increases from two opposite sides of the light guide plate 11 respectively to a center position of the light guide plate 11, two light sources 14 disposed at the two opposite sides of the light guide plate 11 respectively, a reflector 15 disposed under the light guide plate 1, and a back frame 16 having the reflector 15 disposed thereon, in which the back frame 16 accommodates the two light sources 14 and the light guide plate 11.

However, the conventional backlight module 1 has to use the light guide plate 11 which is an integral plate structure (as shown in FIG. 1). In particular, when the light guide plate 11 is applied in an LCD device having a relatively large size, a volume and a weight of the light guide plate 11 are increased correspondingly. In such a manner, the weight of the light guide plate 11, the weight of the backlight module 1, and the cost of the materials for the light guide plate 11 are increased accordingly.

Since the related art need to be improved, the present invention provides a lightweight light guide plate and a backlight module thereof, which can ameliorate the disadvantages of the light guide plate in the related art that the weight of the light guide plate, the weight of the backlight module, and the cost of the materials for the light guide plate are increased.

### SUMMARY OF THE INVENTION

Accordingly, the present invention is directed to a lightweight light guide plate and a backlight module thereof, which are able to reduce a weight of the light guide plate and the backlight module thereof, so as to achieve a lightweight effect.

The present invention is further directed to a lightweight light guide plate and a backlight module thereof; which are able to save the cost of materials for the light guide plate.

As embodied and broadly described herein, the present invention provides a lightweight light guide plate and a backlight module thereof. The lightweight light guide plate includes a light guide plate body whose thickness gradually reduces from four edges of the light guide plate body respectively to a center point of the light guide plate body to form a concave, and a plurality of net points disposed on the concave, in which a unit area density of the plurality of net points gradually increases from the four edges to the center point of the light guide plate body. The backlight module of the lightweight light guide plate includes a light guide plate whose thickness gradually reduces from four edges of the light guide plate body respectively to a center point of the light guide plate body to form a concave, a plurality of net points disposed on the concave of the light guide plate body, in which a unit area density of the plurality of net points gradually increases from the four edges to the center point of the light guide plate body, an optical film group disposed on a plane of the light guide plate body, a plurality of light emitting diodes (LEDs) disposed at the four edges of the light guide plate body respectively, a reflector disposed corresponding to the concave of the light guide plate body, and a back frame having the reflector disposed thereon, in which the back frame accommodates the plurality of LEDs and the light guide plate body and the back frame fixes the plurality of LEDs at the four edges of the light guide plate body.

To make technical features and the achieved efficacies of the present invention more comprehensible, embodiments are illustrated in detail in the following with reference to the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional backlight module.

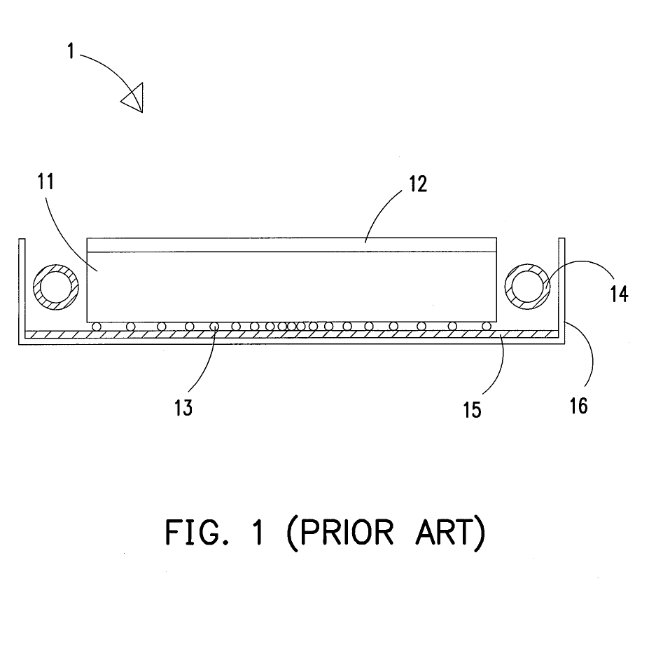

FIG. 2 is a schematic view of a lightweight light guide plate according to an embodiment of the present invention.

FIG. 3 is a schematic cross-sectional view of a backlight module of a lightweight light guide plate according to an embodiment of the present invention.

FIG. 4 is a schematic top view of a backlight module of a lightweight light guide plate according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### Embodiment

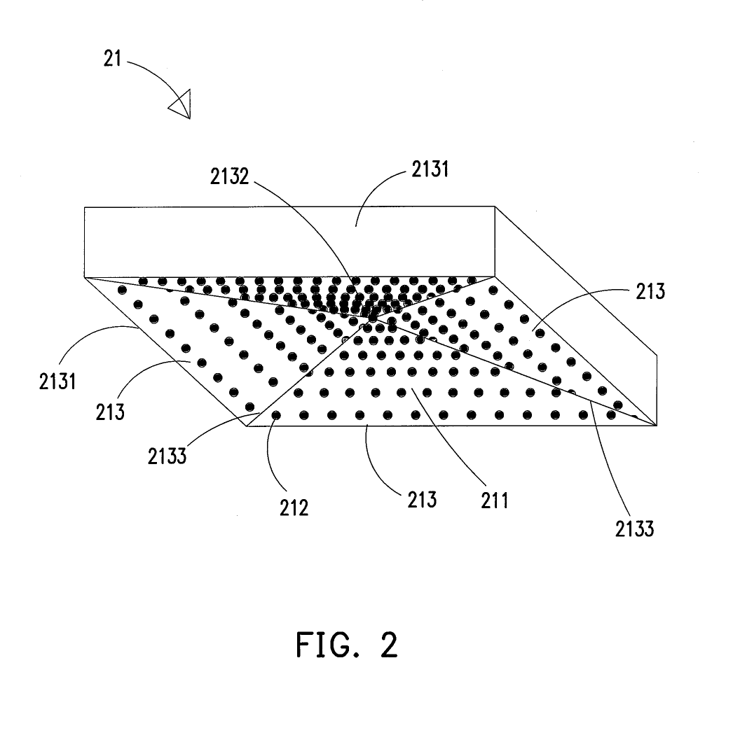

A lightweight light guide plate in the present invention is as shown in FIG. 2. The lightweight light guide plate includes a light guide plate body 21 whose thickness gradually reduces from four edges of the light guide plate body 21 respectively to a center point of the light guide plate body 21 to form a concave 211, and a plurality of net points 212 disposed on the concave 211, in which a unit area density of the plurality of net points 212 gradually increases from the four edges to the center point of the light guide plate body 21.

The light guide plate body 21 includes four triangular tilted blocks 213. A thickness of each triangular tilted block 213 reduces from a base 2131 to a vertex angle 2132. The vertex angle 2132 of each triangular tilted block 213 is disposed at the center point of the light guide plate body 21 and one side 2133 of each triangular tilted block 213 is connected to one side 2133 of another triangular tilted block 213.

Two of the triangular tilted blocks 213 are disposed opposite to each other and the other two triangular tilted blocks 213 are disposed opposite to each other in the same way. When the light guide plate body 21 is a rectangular light guide plate, two bases of the two triangular tilted blocks are greater than that of the other two triangular tilted blocks.

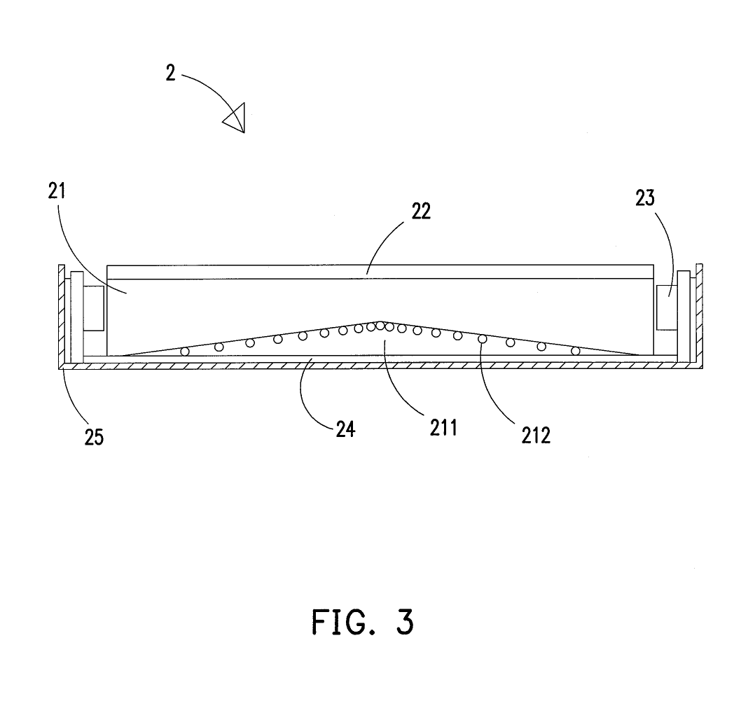

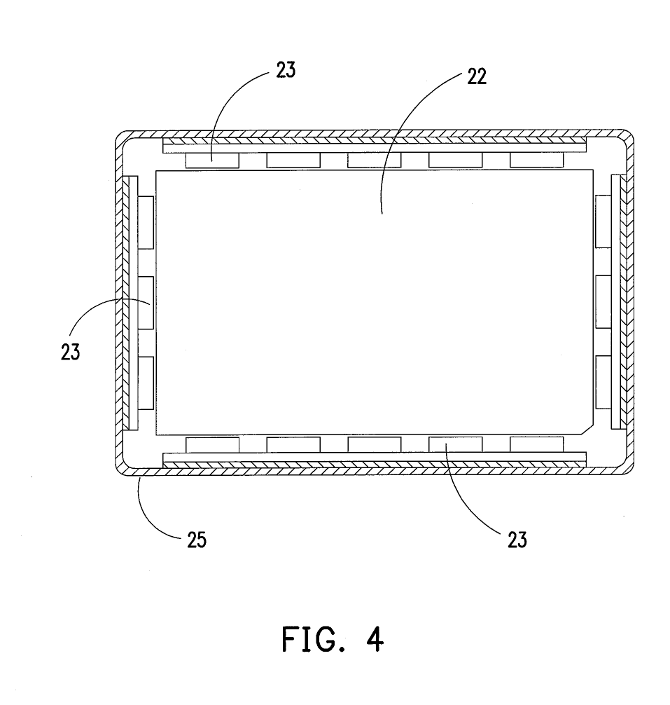

A backlight module 2 of the lightweight light guide plate of the present invention is as shown in FIGS. 3 and 4. The backlight module 2 includes a light guide plate 21 whose thickness gradually reduces from four edges of the light guide plate body 21 respectively to a center point of the light guide plate body 21 to form a concave 211, a plurality of net points 212 disposed on the concave 211 of the light guide plate body 21, in which a unit area density of the plurality of net points 212 gradually increases from the four edges to the center point of the light guide plate body 21, an optical film group 22 disposed on a plane of the light guide plate body 21, a plurality of LEDs 23 disposed at the four edges of the light guide plate body 21 respectively, a reflector 24 disposed corresponding to the concave 211 of the light guide plate body 21, and a back frame 25 having the reflector 24 disposed thereon, in which the back frame 25 accommodates the plurality of LEDs 23 and the light guide plate body 21, and the back frame 25 fixes the plurality of LEDs 23 at the four edges of the light guide plate body 21.

In view of the above, the lightweight light guide plate and the backlight module thereof according to the present invention have the following advantages.

1. The present invention can reduce the weight of the light guide plate and the weight of the backlight module thereof, so as to achieve the lightweight effect.

2. The present invention can save the cost of materials for the light guide plate.

Therefore, the present invention has novelty, non-obviousness and industrial applicability, such that the present invention conforms to the statutory requirements for patentability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lightweight light guide plate, comprising:
a light guide plate body, wherein a thickness of the light guide plate body reduces gradually from four edges of the light guide plate body respectively to a center point of the light guide plate body to form a concave; and
a plurality of net points, disposed on the concave, wherein a unit area density of the plurality of net points gradually increases from the four edges of the light guide plate body to the center point of the light guide plate body.

2. The lightweight light guide plate according to claim 1, wherein the light guide plate body comprises four triangular tilted blocks, a thickness of each triangular tilted block reduces from a base to a vertex angle, the vertex angle of each triangular tilted block is disposed at the center point of the light guide plate body, and one side of each triangular tilted block is connected to one side of another triangular tilted block.

3. The lightweight light guide plate according to claim 1, wherein the light guide plate body is a rectangular light guide plate.

4. The lightweight light guide plate according to claim 3, wherein the rectangular light guide plate comprises four triangular tilted blocks, a thickness of each triangular tilted block reduces from a base to a vertex angle, the vertex angle of each triangular tilted block is disposed at the center point of the light guide, one side of each triangular tilted block is connected to one side of another triangular tilted block, two triangular tilted blocks are disposed opposite to each other and the other two triangular tilted blocks are disposed opposite to each other in the same way, and two bases of the two triangular tilted blocks are greater than that of the other two triangular tilted blocks.

5. A backlight module of a lightweight light guide plate, comprising:
a light guide plate, wherein a thickness of the light guide plate body gradually reduces from four edges of the light guide plate body respectively to a center point of the light guide plate body to form a concave;
a plurality of net points, disposed on the concave of the light guide plate body, wherein a unit area density of the plurality of net points gradually increases from the four edges of the light guide plate body respectively to the center point of the light guide plate body;
an optical film group, disposed on a plane of the light guide plate body;
a plurality of light emitting diodes (LEDs), disposed on the four edges of the light guide plate body respectively;
a reflector, disposed opposite to the concave of the light guide plate body; and
a back frame, provided with the reflector thereon;
wherein the back frame accommodates the plurality of LEDs and the light guide plate body, and fixes the plurality of LEDs at the four edges of the light guide plate body.

6. The backlight module of the lightweight light guide plate according to claim 5, wherein the light guide plate body comprises four triangular tilted blocks, a thickness of each triangular tilted block reduces from a base to a vertex angle, the vertex angle of each triangular tilted block is disposed at the center point of the light guide plate body, and one side of each triangular tilted block is connected to one side of another triangular tilted block.

7. The backlight module of the lightweight light guide plate according to claim 5, wherein the light guide plate body is a rectangular light guide plate.

8. The backlight module of the lightweight light guide plate according to claim 7, wherein the rectangular light guide plate comprises four triangular tilted blocks, a thickness of each triangular tilted block reduces from a base to a vertex angle, the vertex angle of each triangular tilted block is disposed at the center point of the light guide plate body, one side of each triangular tilted block is connected to one side of another triangular tilted block, two triangular tilted blocks are disposed opposite to each other and the other two triangular tilted blocks are disposed opposite to each other in the same way, and two bases of the two triangular tilted blocks are greater than that of the other two triangular tilted blocks.
